(19) United States
(12) Patent Application Publication
(10) Pub. No.: US 2013/0128987 A1
(43) Pub. Date: May 23, 2013

(54) Communication of data blocks over a communication system

(71) Applicant: Canon kabushiki Kaisha, Tokyo (JP)

(72) Inventors: Pierre VISA, Rennes (FR); Falk TANNHAUSER, Rennes (FR); Julien SEVIN, Saint Aubin du Cormier (FR); Mounir ACHIR, Chantepie (FR)

(73) Assignee: CANON KABUSHIKI KAISHA, Tokyo (JP)

(21) Appl. No.: 13/679,566

(22) Filed: Nov. 16, 2012

(30) Foreign Application Priority Data
Nov. 22, 2011 (GB) GB1120140.7

(51) Int. Cl. H04N 7/26; H04B 1/04; H04B 1/10

(52) U.S. Cl. CPC H04N 19/00854; H04B 1/0483; H04B 1/10
USPC 375/240.24; 375/295; 375/349

(57) ABSTRACT

The invention relates to a method of transmitting and receiving a primary data stream of data blocks, each data block formed by a plurality of N symbols, over a communication system that is robust to transmission errors and signal interruptions due to obstacles, and that minimizes bandwidth usage. The transmitting method comprising: forming a secondary data stream comprising shortened data blocks formed from the M most significant symbols of data blocks of the primary data stream, where M<N; and transmitting the primary and secondary data streams in accordance with, respectively, first and second transmission parameters; wherein the first and second transmission parameters causing the transmitting of the secondary data stream to be more robust against transmission errors than the transmitting of the primary data stream.

### BACKGROUND OF THE INVENTION

### Field of the Invention

This invention relates to the data communication field, and more particularly to wireless communication of uncompressed video information.

### CROSS-REFERENCE TO RELATED APPLICATIONS

This application claims the benefit under 35 U.S.C. §119(a)-(d) of United Kingdom Application No. 1120140.7, filed on Nov. 22, 2011 and entitled “Communication of data blocks over a communication system”.

The above cited patent application is incorporated herein by reference in its entirety.

### DESCRIPTION OF THE BACKGROUND ART

An increasing number of multimedia applications are requiring a bandwidth of several Gbps (Gb/s) for their transmission. For instance, a video application conforming to the high definition (HD) video format, i.e. 60 Hz frames of 1920 columns and 1080 rows, requires a channel bandwidth of about 3 Gbps. Such data rates are not achievable in current 802.11 systems using the 2.4 GHz and 5 GHz radio bands. The use of the 57-66 GHz millimeter-wave unlicensed spectrum, referred to as 60 GHz millimeter wave technology, can provide an attractive solution considering the offered bandwidth. Restrictions related to the use of this band should however be observed such as regulatory limitations of the transmission power, e.g. 40 dBm according to the recommendations of the US Federal Communications Commission (FCC), as well as the physical properties of the 60 GHz band which make the communications very sensitive to shadowing. In view of these constraints, techniques for improving the robustness of data transmission need thus to be provided.

One known technique for increasing the robustness of the communications is to use several transmission paths and time slots when transmitting the data to create space and time diversity. Thus if one transmission path is interrupted by an obstacle, the receiver can still receive data through another transmission path. This technique has the drawback of requiring a lot of bandwidth as the same information is duplicated over the different transmission paths. This is particularly costly for the transport of uncompressed HD video data.

The present invention has been devised to address at least the foregoing concern. More specifically, an object of at least one aspect of the present invention is to improve the robustness of data transmission in a communication system, while reducing the required bandwidth for ensuring such robust transmission. Preferably this improvement should be achieved with no or no significant additional information overhead.

### SUMMARY OF THE INVENTION

To this end, the present invention provides according to a first aspect a method of transmitting data over a communication system. The method comprising:

obtaining a primary data stream comprising data blocks over a communication system, each data block formed by a plurality of N symbols

forming a secondary data stream comprising shortened data blocks formed from the M most significant symbols of data blocks of the primary data stream, where M<N; and

transmitting the primary and secondary data streams in accordance with, respectively, first and second transmission parameters;

wherein the first and second transmission parameters causing the transmitting of the secondary data stream to be more robust against transmission errors than the transmitting of the primary data stream.

Consequently, if the primary data stream is corrupted by errors during transmission, the receiver may still receive the secondary data stream which can be used in a degraded mode.

Advantageously, the method comprising, prior to the transmitting, a step of setting the first and the second transmission parameters for causing the transmitting of the secondary data stream to be more robust against errors than the transmitting of the primary data stream. This makes it possible to adapt the robustness according to channel conditions or to the desired quality of the data blocks at the receiver side.

According to a preferred implementation, the first and second transmission parameters include data encoding parameters and data modulation parameters. This provides many options for setting the robustness of the primary and secondary data streams in terms of possible range and granularity for the robustness.

According to one implementation, the data encoding parameters include a code rate of an error correction code. Thus, setting the first and second transmission parameters comprises setting the code rate of the first transmission parameters to be greater than the code rate of the second transmission parameters.

According to another implementation, the data modulation parameters include an order of modulation scheme. Thus, setting the first and second transmission parameters comprises setting the modulation scheme order of the first transmission parameters to be greater than the modulation scheme order of the second transmission parameters.

According to one implementation, the primary and secondary data streams are transmitted in data packets and wherein an indication of the type of the embodied data stream is transmitted in a header of each data packet. This makes it possible to differentiate between primary and secondary data streams. Alternatively, the differentiation can be performed by assigning dedicated communication channels to each type of the data stream. Thus, differentiation can be performed according to the time slot or the transmission path used for transmitting/receiving the data stream.

Advantageously, each data block contains information of at least one pixel component of an uncompressed video frame.

According to one embodiment of the invention, each data block contains the encoding of one pixel component and wherein a shortened data block contains the two most significant bits of the pixel component contained in a corresponding data block.

According to another embodiment of the invention, each data block contains the encoding of three pixel components (Cb, Y, Cr) and wherein a shortened data block contains the luminance component (Y) contained in a corresponding data block.

According to a second aspect, the present invention provides a method of receiving dataover a communication system. The method comprising:

receiving a primary data stream in accordance with first reception parameters, the primary data stream comprising data blocks formed by a plurality of N symbols;

receiving a secondary data stream in accordance with second reception parameters, the secondary data stream comprising shortened data blocks formed from the M most significant symbols of data blocks of the primary data stream, where M<N, and wherein the first and second reception parameters correspond to a more robust protection, against transmission errors, of the secondary data stream relatively to the primary data stream; and

recovering data blocks based on data contained in the received primary and secondary data streams.

It is thus possible to optimize the bandwidth used for transmitting the data blocks and at the same time keeping the transmission robust.

In one implementation, if both a first data block of the primary data stream and a second data block of the secondary data stream corresponding to the first data block are received, the recovering comprises a step of concatenating the M most significant symbols of the second data block with the N-M least significant symbols of the first data block. This makes it possible to reduce or remove residual errors that may still be present in a data block after decoding, particularly in the most significant (important) symbols part of the data block.

In one implementation, if the first data block is not received and the second data block is received and is a shortened data block, the recovering comprises the steps of:

determining N-M symbols by applying an error concealment or interpolation technique; and

concatenating the M most significant symbols of the second data block with the determined N-M symbols.

Thus it is still possible to deliver a useful version of the data blocks even when channel conditions severely deteriorate.

In one implementation, if the first data block is received and the second data block is not received, the recovering consists in selecting the first data block as a recovered data block. Thus, the primary data stream is used at the receiver.

In one implementation, the method comprising, prior to the receiving, a step of configuring reception means with first and second reception parameters for enabling the receiving of primary and secondary data streams. This makes it possible to adapt the reception parameters to those used by the transmitter.

According to a third aspect, the present invention provides a transmitting device for transmitting data over a communication system. The device comprising:

means for obtaining a primary data stream comprising data blocks, each data block being formed by a plurality of N symbols;

means for forming a secondary data stream comprising shortened data blocks formed from the M most significant symbols of data blocks of the primary data stream, where M<N; and

means for transmitting the primary and secondary data streams in accordance with, respectively, first and second transmission parameters;

wherein the first and second transmission parameters causing the transmitting of the secondary data stream to be more robust against transmission errors than the transmitting of the primary data stream.

According to a fourth aspect, the present invention provides a receiving device for receiving data over a communication system. The device comprising:

means for receiving a primary data stream comprising data blocks in accordance with first reception parameters, the primary data stream comprising data blocks formed by a plurality of N symbols;

means for receiving a secondary data stream in accordance with second reception parameters, the secondary data stream comprising shortened data blocks formed from the M most significant symbols of data blocks of the primary data stream, where M<N, and wherein the first and second reception parameters correspond to a more robust protection, against transmission errors, of the secondary data stream relatively to the primary data stream; and

means for recovering data blocks based on data contained in the received primary and secondary data streams.

The present invention also extends to programs which, when run on a computer or processor, cause the computer or processor to carry out the method described above or which, when loaded into a programmable device, cause that device to become the device described above. The program may be provided by itself, or carried by a carrier medium. The carrier medium may be a storage or recording medium, or it may be a transmission medium such as a signal. A program embodying the present invention may be transitory or non-transitory.

The particular features and advantages of the transmitting and receiving devices and the program being similar to those of the methods for transmitting and receiving data blocks, they are not repeated here.

### BRIEF DESCRIPTION OF THE DRAWINGS

FIG. 1 depicts for illustrative purposes a wireless communication network employing spatial diversity.

FIG. 2 depicts a time division multiplexing (TDM) used for sharing access to the radio medium.

FIG. 3 illustrates a functional block diagram of a communication device that implements both a transmitter and a receiver.

FIG. 4 shows an example of a portion of an uncompressed video frame encoded with a 4:4:4 sub-sampling.

FIG. 5 shows an example of a portion of an uncompressed video frame encoded with a 4:2:2 sub-sampling.

FIG. 6 shows an example of a portion of an uncompressed video frame encoded with a 4:2:0 sub-sampling.

FIG. 7 is a flowchart illustrating a method of transmitting data blocks of a primary data stream according to a first aspect of the invention.

FIG. 8 is a flowchart illustrating a method of receiving data blocks of a primary data stream according to a second aspect of the invention.

FIG. 9a illustrates a global flowchart for transmitting data blocks according to the first embodiment of the invention.

FIG. 9b illustrates a global flowchart for receiving data blocks according to the first embodiment of the invention.

FIG. 10 illustrates the flowchart for forming the primary and secondary data streams according to the first embodiment of the invention.

FIG. 11 illustrates the flowchart for encoding and modulating the primary and secondary data packets according to a first embodiment of the invention.

FIG. 12 illustrates the flowchart for demodulating and decoding received primary and secondary data packets according to the first embodiment of the invention.

FIG. 13 illustrates the flowchart for recovering a stream of data blocks according to a first embodiment of the invention.

FIG. 14 illustrates the flowchart for encoding and modulating the primary and secondary data packets according to a second embodiment of the invention.

FIG. 15 illustrates the flowchart for demodulating and decoding received primary and secondary data packets according to the second embodiment of the invention.

FIG. 16 illustrates the flowchart for forming the primary and secondary data streams according to the third embodiment of the invention.

FIG. 17 illustrates the flowchart for recovering a stream of data blocks according to a third embodiment of the invention.

FIG. 18 depicts a time division multiplexing (TDM) used for sharing access to the radio medium according to one of the embodiments of the invention.

### DETAILED DESCRIPTION OF THE INVENTION

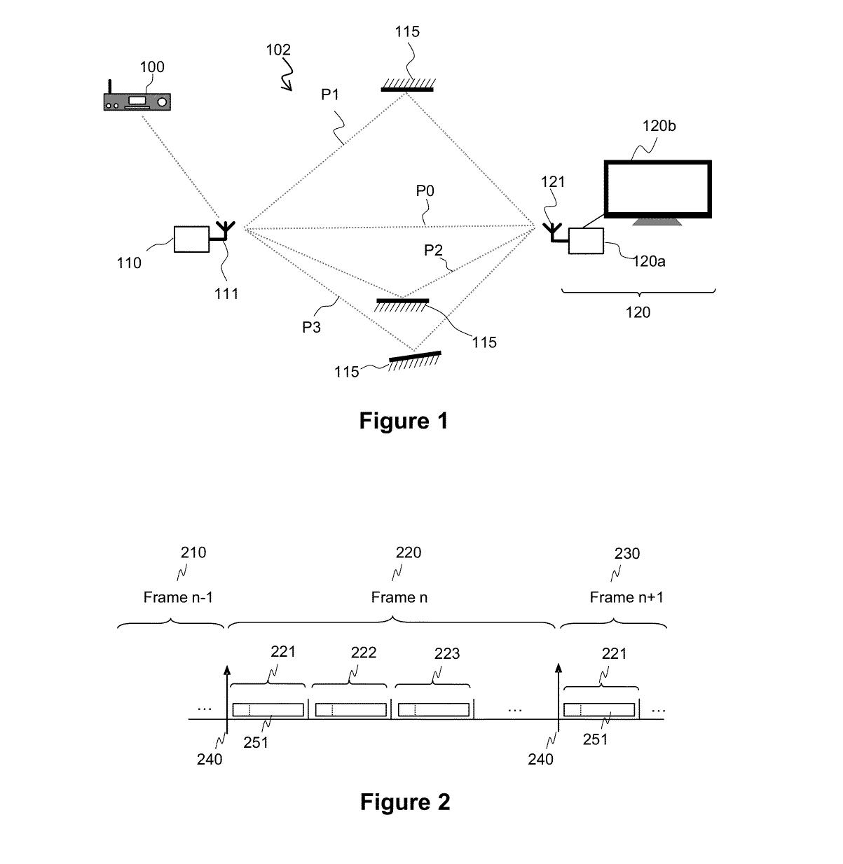

FIG. 1 depicts for illustrative purposes a wireless communication network 102 employing spatial diversity. Spatial diversity relies on the use of a plurality of transmission paths between communicating devices. Typically, wireless communication network 102 operates in the unlicensed 60 GHz frequency band (millimeter waves) for providing enough bandwidth capacity to support the transport of uncompressed HD video content.

Network 102 comprises a first device 110 embodying a transmitter (Tx) and a second device 120 embodying a receiver (Rx). In this particular example, the second device 120 is composed of a communication device 120a connected to the wireless network and of a display device 120b connected to the communication device 120a for rendering the received data content, e.g. displaying the video. It is to be noted that the first device 110 may also represent a relay device, the originator of the data being then represented by another device 100 belonging to the communication network. It is common to have a meshed network comprising relay devices for relaying data between different devices to cope with the short range of the millimeter waves.

A signal emitted by antenna 111 of first device 110 may reach antenna 121 of second device 120 through a line-of-sight (LOS) transmission path P0 if it is not blocked by any obstacle. In addition, the signal may be reflected by objects 115 which may cause the establishment of a plurality of non line-of-sight (NLOS) transmission paths P1, P2 and P3.

Transmission paths P0, P1, P2, P3 may be created by different radiation patterns/configurations of antenna 111 of first device 110 and detected by different receiving patterns/configurations of antenna 121 of second device 120. A narrow beam antenna (directional antenna) can be used at the first device 110 when emitting a signal and/or at the second device 120 when receiving a signal. Steering an antenna to a given orientation corresponds to configuring its parameters (for example the weighting coefficients associated with the elements of an antenna array) such that the radiation of the signal, in case of emission, or the antenna sensitivity, in case of reception, is accentuated in that given direction relatively to other directions.

The setting up of a plurality of transmission paths in wireless communication network 102 is advantageously used in the present invention to create a plurality of communication channels between the transmitter Tx and the receiver Rx over which radio packets are transmitted.

For example, time division multiplexing (TDM) may used for sharing access to the radio medium as depicted in FIG. 2. A plurality of time slots 221, 222, 223, . . . are provided periodically in every frame 210, 220, 230. The start of a frame is signaled by means of a beacon signal 240 consisting of a predetermined pattern of data symbols. A communication channel is created by associating one given time slot of a series of frames, e.g. 221, with one given transmission path. Sending radio packets, e.g. 251, over said communication channel corresponds to configuring transmitter antenna 111 to radiate in at least the direction of the given transmission path and emitting radio signals representative of said radio packets during the given time slot 221 in the series of frames. Receiving data from said communication channel corresponds to configuring receiver antenna 121 to be sensitive in at least the direction of the given transmission path and receiving radio signals representative of said data during the same given time slot in the series of frames. Consequently, different communication channels correspond to different transmission time slots and/or different transmission paths. Both spatial and temporal diversities are thus ensured when transmitting over the different communication channels.

In another embodiment of the invention, a frequency division multiple access (FDMA) scheme may be used for sharing the radio medium. A communication channel is then created by associating one given carrier frequency with one given transmission path. Sending data over said communication channel corresponds to configuring transmitter antenna 111 to radiate in at least the direction of the given transmission path and emitting radio signals representative of said radio packets by modulating the given carrier frequency. Receiving radio packets from said communication channel corresponds to configuring receiver antenna 121 to be sensitive in at least the direction of the given transmission path and receiving signals representative of said radio packets by demodulating the given carrier frequency. Consequently, different communication channels correspond to different carrier frequencies and/or different transmission paths. Both spatial and spectral diversities are thus ensured when transmitting over the different communication channels.

In a further embodiment, the two above embodiments are combined. A communication channel is created by associating one given transmission path with both one given time slot of a series of frames and one given carrier frequency. Consequently, different communication channels correspond to different carrier frequencies and/or different transmission time slots and/or different transmission paths. Spatial, temporal and spectral diversities are thus ensured when transmitting over the different communication channels.

In a variant implementation of the invention, the first device 110 and second device 120 each embodies both a transmitter and a receiver to establish a bi-directional communication. This makes it possible for example to insert feedback control information in the data flow transmitted in the reverse direction from the second device to the first device. In this implementation variant, the two devices share the same hardware platform. An apparatus based on this hardware platform is referred to generically hereinafter as a communication device.

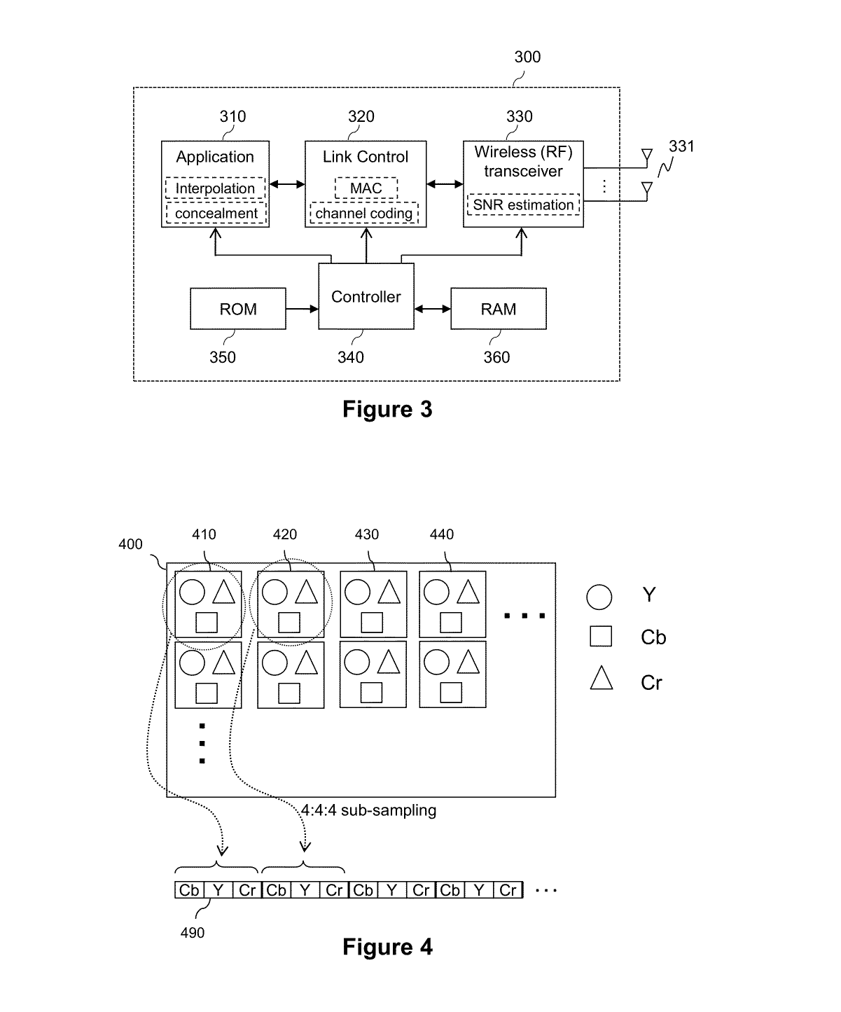

FIG. 3 illustrates a functional block diagram of a communication device 300 that implements both a transmitter Tx and a receiver Rx. Communication device 300 includes a wireless transceiver (transmitter-receiver) 330, a link control unit 320 and an application unit 310, each of which is also coupled to a controller 340. The communication device furthermore includes a ROM 350 and a RAM 360 (computer readable storage medium) for data and program storage.

Typically, controller 340 is embodied as a central processing unit (CPU), which operates in accordance with a program stored in the ROM 350. The controller provides a work area in the RAM 360 and accesses and uses the work area during operation.

The wireless transceiver 330 is typically radio frequency (RF) transceiver circuitry that is connected to an antenna 331. The RF transceiver performs functions such as modulation/demodulation, signal-to-noise ratio (SNR) estimation and antenna control. The functions of the transceiver, particularly the modulation and demodulation, are operated in accordance with transceiver parameters such as for example the type of the modulation scheme used and the order of the modulation scheme (data modulation parameters). These transceiver parameters may be controlled by the controller 340 to adapt the robustness of the transmitted data according to an embodiment of the invention.

The link control unit 320 performs functions of media access control (MAC) and channel coding. Channel coding protects radio packets against channel errors by encoding transmitted radio packets using an error correction code at the transmitter and decoding the received radio packets at the receiver. The functions of the link control unit, particularly the channel coding, are operated in accordance with link control parameters such as for example the type of the coding scheme (error correction code) used and the code rate of the error correction code (data encoding parameters). These link control parameters may be controlled by the controller 340 to adapt the robustness of the transmitted data according to an embodiment of the invention.

Transceiver parameters and link control parameters are referred to more generally as transmission parameters when they relate to the transmitter and reception parameters when they relate to the receiver. Although the type of the modulation scheme, the order of the modulation scheme, the type of the coding scheme and the code rate has been provided as examples of transmission/reception parameters, it is to be understood that any parameter of the transmission chain capable of influencing the robustness of the transmitted data is a candidate parameter that can be used in one embodiment of the invention.

When the communication device 300 is acting as a transmitter, application unit 310 generates a video data stream from a video frames delivered by a local or remote video source such as a HD player or set-top box for example. An example of packetizing the video frames into a data stream is described below with reference to FIGS. 4 to 6.

When the communication device 300 is acting as a receiver, application unit 310 generates video frames for display or storage for example from received video data stream comprising pixel components with the possibility that some of the components are missing. Missing pixel components are reconstructed using error concealment or interpolation techniques.

Controller 340 will normally control overall data processing over the received or to be transmitted data streams, whereas signal processing operations associated with communication functions are typically performed in RF transceiver circuitry 330.

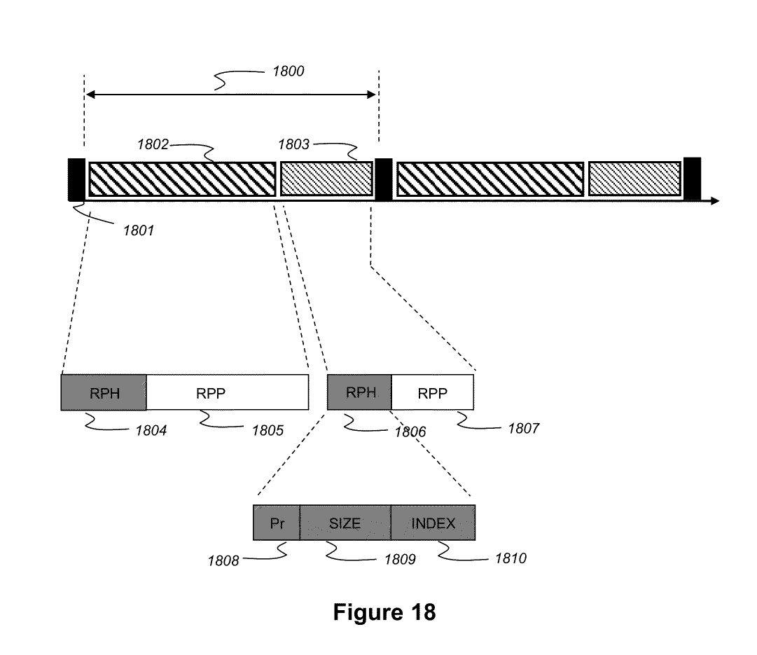

A data stream is divided into data packets for applying channel coding function by the link control unit 320. Data packets as encoded by the link control unit are then processed by the transceiver 330 before their emission. Physical packets when emitted over a radio communication channel are referred to as radio packets. Radio packets contain information representative of the content of a data packet as encoded by the link control unit and all the necessary protocol overhead information (cf. FIG. 18 providing details on the structure of one radio packet 1803).

Each pixel of an uncompressed video frame is represented by 3 video components Y, Cb and Cr. Y, referred to as luminance component, represents the brightness of the video frame (image) whereas Cb and Cr, referred to as chrominance components, represent the colour information; the blue information minus the brightness for Cb and the red information minus the brightness for Cr. Each pixel component may be displayed as various color depths such as 8-bits, 12 bits, 16 bits or 32 bits.

The human vision system is less sensitive to color than brightness. More precisely, the human eye is able to distinguish more accurately details conveyed by differences in luminance than details conveyed by differences in chrominance. Based on this fact, the modern HD video formats uses a technique referred to as “sub-sampling” which consists in deleting some colour information in the video pixel components. In other word, it consists in sampling the colour information at a lower resolution. The main interest is to reduce the amount of data generated by the video frame without significant visual degradation. A number of different sub-sampling levels or schemes are used in video compression standards. The level of sub-sampling is often expressed by using a string of 3 integers separated by colons which represents the link between the luminance sampling frequency and the chrominance sampling frequencies.

FIG. 4 shows an example of a portion of an uncompressed video frame 400 encoded with a 4:4:4 sub-sampling (actually, no sub-sampling here because all information is kept). Each pixel 410, 420, 430, 440 contains the 3 video components (Y, Cb, Cr). So for each group of 4 pixels, there are 4 luminance components Y, 4 chrominance components Cb, and 4 chrominance components Cr.

For each sub-sampling scheme, there may be several data stream arrangements. For example, it is furthermore illustrated in FIG. 4 one way of arranging the values of the Y, Cb, and Cr components into a data stream 490, for presentation to the link control module 320 that encodes the ensemble of data. The illustrated arrangement operates on rows of the video frame, each pixel being processed independently.

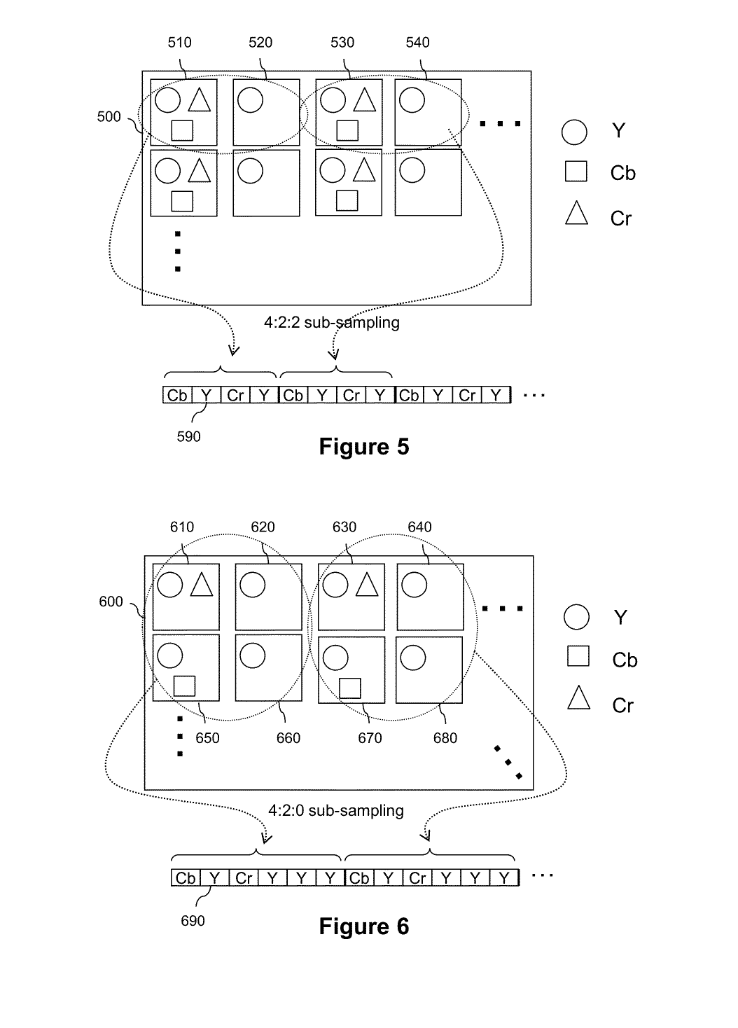

FIG. 5 shows an example of a portion of an uncompressed video frame 500 encoded with a 4:2:2 sub-sampling. In this sub-sampling scheme, the chrominance components are sampled at half the horizontal resolution of the luminance component compared to a 4:4:4 sub-sampling scheme. So, in each row of the video frame 500, 4 consecutive pixels 510, 520, 530 and 540 contain 4 luminance components (Y), 2 chrominance components Cb and 2 chrominance components Cr. One luminance component and 2 chrominance components for pixels 510 and 530, only one luminance component for pixels 520 and 540. One way of arranging the values of the Y, Cb, and Cr components into a data stream 590 is furthermore illustrated.

FIG. 6 shows an example of a portion of an uncompressed video frame 600 encoded with a 4:2:0 sub-sampling. In this sub-sampling scheme, the chrominance components are sampled at half the horizontal and vertical resolutions of the Y component of the luminance component compared to a 4:4:4 sub-sampling scheme. So, in each odd row of the video frame 600, 4 consecutive pixels 610, 620, 630 and 640 contain all 4 luminance components Y, 2 chrominance components Cr and zero chrominance components Cb. One luminance component Y and one chrominance component Cr for pixels 610 and 630, only one luminance component Y for pixels 620 and 640. In each even row of the video frame 600, 4 consecutive pixels 650, 660, 670 and 680 contain all 4 luminance components Y, 2 chrominance components Cb and zero chrominance components Cr. One luminance component Y and one chrominance component Cb for pixels 650 and 670, only one luminance component Y for pixels 660 and 680. One way of arranging the values of the Y, Cb, and Cr components into a data stream 690 is furthermore illustrated.

The video decoder, implemented in the application unit 310 of the receiver, applies an interpolation method or a simple duplication to display all the pixels if the video is sampled with a sampling less than 4:4:4. For instance, in the context of 4:2:2, the decoder duplicates the chrominance information of the pixel 510 in the pixel 520. This means that the red, blue and green colours of the pixel 520 is computed by using the luminance of the pixel 520 and the two chrominance components (Cb and Cr) of the pixel 510.

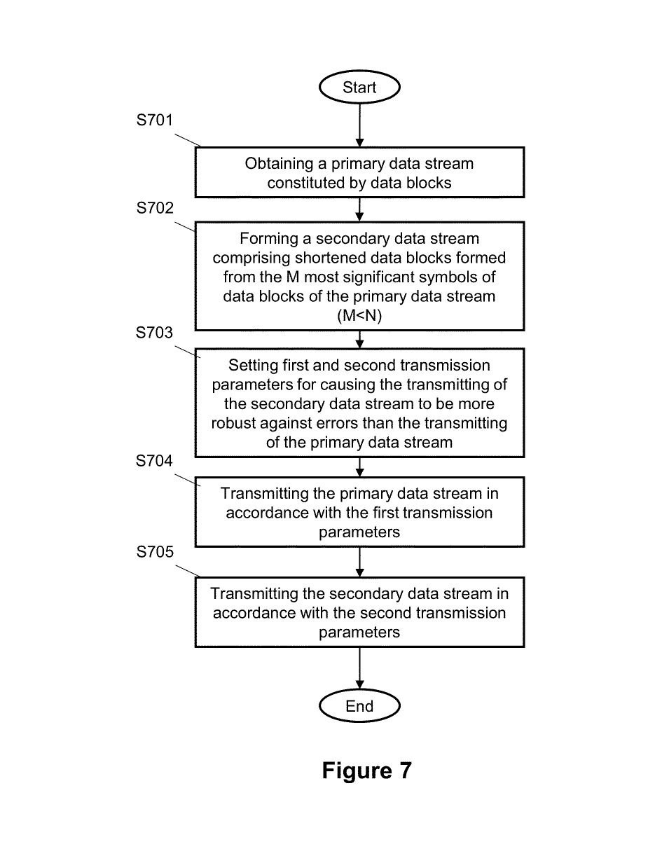

FIG. 7 is a flowchart illustrating a method of transmitting data according to a first aspect of the invention. The steps may be performed, for example, by first device 110 to transmit the data via two communication channels to second device 120 of the communication system 102. The steps may be implemented in hardware, software, firmware or any combination thereof. If implemented in software, the flowchart may correspond to a segment of the program stored in the ROM 350 of first device 110.

At step S701, a data stream is obtained from the packetizing of video frames. This stream is referred to as a primary data stream and it is constituted by data blocks. The obtained primary data stream is for example one of the arrangements of pixel components 490, 590 and 690 illustrated in FIGS. 4, 5 and 6.

More generally, the invention is adapted to the transport of any primary data stream comprising data blocks where each data block is formed by a plurality of N symbols. Typically, a symbol corresponds to one binary information or bit and the data block corresponds to the encoding of one component, the size N being thus 8, 12, 16 or 32 bits depending on the color depth used. Other arrangements of data blocks may be envisaged also, for example for data stream 490, a symbol may correspond to the encoding of one component (8, 12, 16 or 32 bits) and the data block may correspond to the grouping of 3 symbols (N=3) that represent the 3 components of a pixel.

At step S702, a secondary data stream is formed by selecting only the most significant information of at least some of the data blocks of the primary data stream. The secondary data stream comprises thus shortened data blocks formed by the M most significant symbols of some or all of the data blocks of the primary data stream, where M<N. More generally, the shortened data blocks may be formed from the M most significant symbols where the information of the M symbols is encoded differently in the shortened data blocks. According to particular implementation, if only some of the data blocks of the primary data stream are taken into account for forming the shortened data blocks, remaining data blocks of the primary data stream are included without shortening into the secondary data stream.

At step S703, first and second transmission parameters are set for causing the transmitting of the secondary data stream to be more robust against errors than the transmitting of the primary data stream. The first transmission parameters are associated to the transmission of the primary data stream. The second transmission parameters are associated to the transmission of the secondary data stream. Typically, the first and second transmission parameters are the parameters operating the link control unit 340 and the wireless transceiver 330 which are capable of controlling the reliability of the transmitting of the data streams. These transmission parameters include link control parameters of the link control unit 340 and transceiver parameters of the wireless transceiver 330. For example and as indicated above, these parameters may include the type and the order of the modulation scheme, the type of the coding scheme and the code rate.

The code rate of an error correction code, for example a convolutional code, is indicative of the portion of a coded sequence of information that is non-redundant. The code rate is typically a fractional number k/n indicating that for every k symbols of non-redundant (useful) information, the coder generates totally n symbols of data, of which n-k are redundant. Consequently, the lower the code rate is, the more robust the transmission of the coded data would be. According to one implementation of the invention, setting the first and second transmission parameters comprises setting the code rate of the first transmission parameters to be greater than the code rate of the second transmission parameters.

The order of a digital modulation scheme is the number of different modulation symbols that can be transmitted using that modulation scheme. The order of a binary shift keying (BSK) modulation scheme is two because only two modulation symbols can be transmitted (usually denoted as “−1” and “1”). The order of the quadrature phase shift keying (QPSK) is 4 and more generally the order is m for a m-ary quadrature amplitude modulation (m-QAM). Consequently, the lower the modulation order is, the more robust the transmission of the modulated data would be. According to another implementation of the invention, setting the first and second transmission parameters comprises setting the modulation scheme order of the first transmission parameters to be greater than the modulation scheme order of the second transmission parameters.

According to a further implementation of the invention, setting the first and second transmission parameters comprises setting both the code rate and the modulation scheme order of the first transmission parameters to be greater, respectively, than the code rate and the modulation scheme order of the second transmission parameters.

At step S704, the primary data stream is transmitted in accordance with the first transmission parameters and at step S705 the secondary data stream is transmitted in accordance with the second transmission parameters. Typically, each data stream is transmitted over a distinct communication channel. Preferably communication channels formed by distinct transmission paths are selected for ensuring spatial diversity.

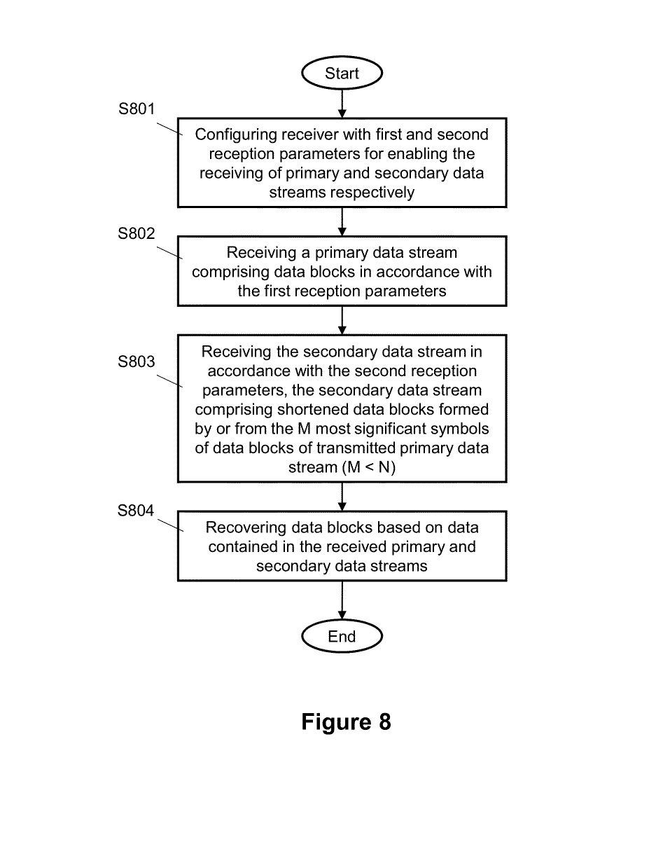

FIG. 8 is a flowchart illustrating a method of receiving data blocks of a primary data stream according to a second aspect of the invention. The steps may be performed, for example, by second device 120 to receive the data blocks via two communication channels from first device 110 of the communication system 102. The steps may be implemented in hardware, software, firmware or any combination thereof. If implemented in software, the flowchart may correspond to a segment of the program stored in the ROM 350 of second device 120.

At step S801, the receiver is configured with first and second reception parameters for enabling the receiving of a primary and a secondary data streams respectively. Typically, each data stream is received over a distinct communication channel.

The first and second reception parameters are the parameters operating the link control unit 340 and the wireless transceiver 330 at the second device 120. These reception parameters include link control parameters of the link control unit 340 and transceiver parameters of the wireless transceiver 330. For example and as indicated above, these parameters may include the type and the order of the modulation scheme (data encoding parameters), the type of the coding scheme and the code rate (data modulation parameters). The configuring of these parameters is performed in accordance with the transmission parameters used at the transmitter so that to make it possible to decode and to demodulate the signal that was firstly encoded and modulated by the transmitter. Furthermore, the first and second reception parameters correspond to a more robust protection against transmission errors of the secondary data stream relatively to the primary data stream.

At step S802, the primary data stream is received in accordance with the first reception parameters. The primary data stream comprising data blocks each formed by a plurality of N symbols.

At step S803, the secondary data stream is received in accordance with the second reception parameters. The secondary data stream comprising shortened data blocks formed by or from the M most significant symbols of data blocks of the primary data stream, where M<N. These shortened data blocks may form some or all of the data blocks of the secondary data stream. If the shortened data blocks form only some of the data blocks of the secondary data stream, the remaining data blocks may be formed by non-shortened data blocks of the primary data stream.

Both the primary data stream and the secondary data stream may have been subject to errors during their transmission. The operations of demodulating and decoding carried out during the reception steps S802 and S803 aim at removing any potential errors from the received data streams.

It should be noted however that, if the communication channel conditions are degraded or the transmission path used is blocked by an obstacle, the demodulator and/or the decoder may fail to retrieve certain data blocks which would then be considered as not received by the application unit 310.

It should be noted furthermore that depending on the correction capacity of the error correction code, data blocks that have been decoded successfully may still contain residual errors. Error correcting codes having a lower code rate deliver decoded data blocks containing lower residual errors than data blocks decoded with a higher code rate under the same channel conditions. It is thus very likely that the data blocks of the secondary data stream are more reliable than the data blocks of the primary data stream.

At step S804, the information contained in both the primary and the secondary data streams is used to recover a stream of data blocks. Relying on both data stream makes it possible advantageously to reduce the residual error rate in the recovered data packets while maintaining a robust transmission if the quality of one of the communication channels transporting the data streams deteriorates or one communication channel is interrupted. Furthermore, the bandwidth necessary for transporting the first and the second data streams is also reduced as it will be illustrated hereinafter according to the different embodiments of the invention.

### First Embodiment

In this embodiment we consider a primary data stream formed by sub-sampling uncompressed video frames according to 4:2:2 sub-sampling scheme as depicted in FIG. 5. Pixel components are assumed to be coded with 8 bits and each data block of the primary stream corresponds to one component (N=8 bits). It is furthermore assumed that M=2, which means that the M most significant symbols in this embodiment correspond to the two most significant bits (MSB) of the 8 bits data block.

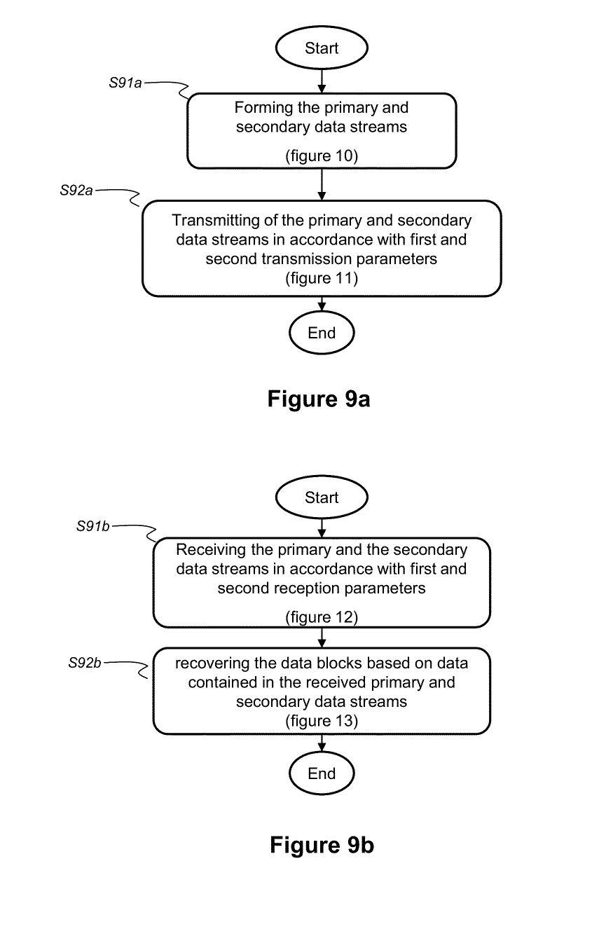

FIG. 9a illustrates a global flowchart for transmitting data blocks according to the first embodiment of the invention and implemented by first device 110.

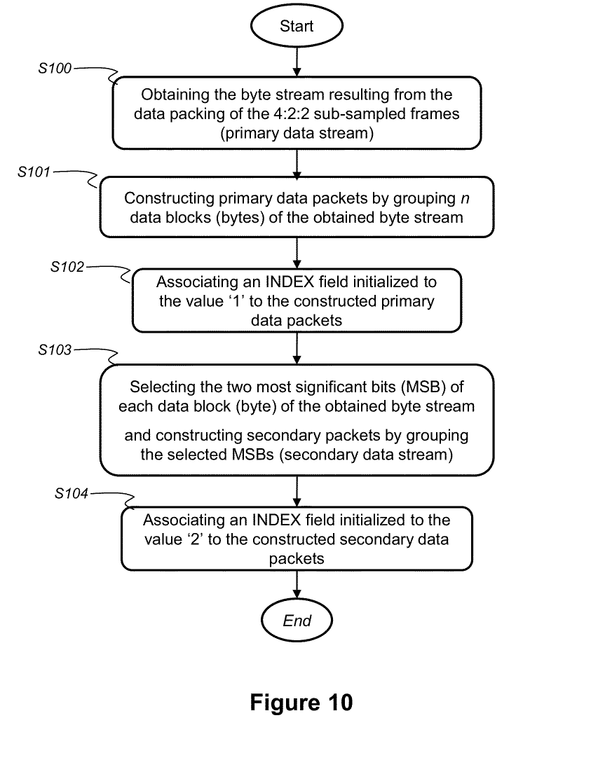

This global flowchart comprises a first main step S91a for forming the primary and secondary data streams. The details of this step are provided with reference to FIG. 10.

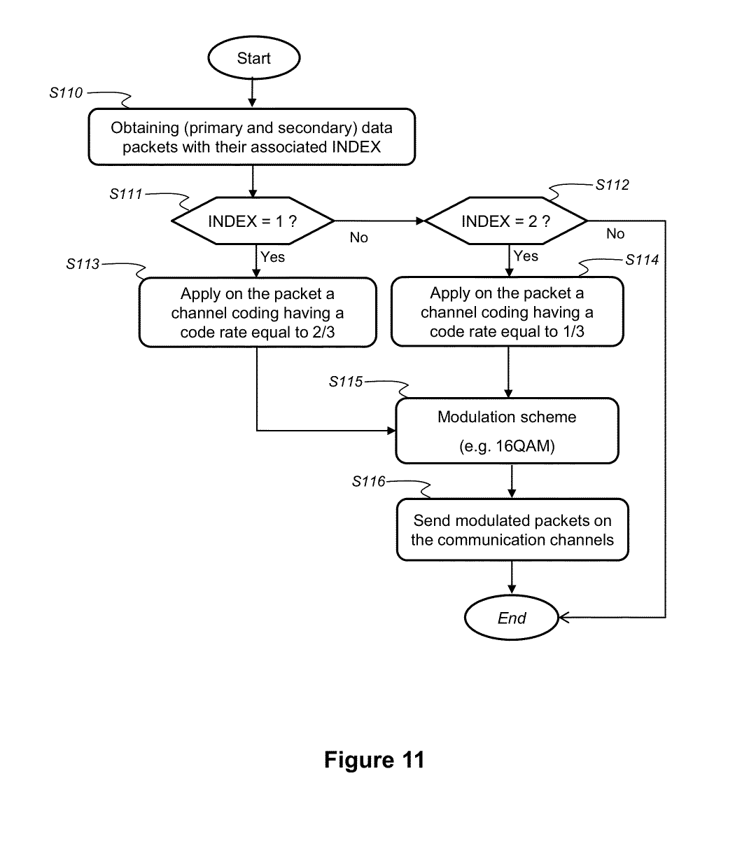

The flowchart further comprises a second main step S92a for transmitting the primary and the secondary data streams in accordance with first and second transmission parameters. According to one implementation of the invention, this second step concerns the configuring of the channel coding and the modulation as is detailed with reference to FIG. 11.

FIG. 9b illustrates a global flowchart for receiving data blocks according to the first embodiment of the invention and implemented by second device 120.

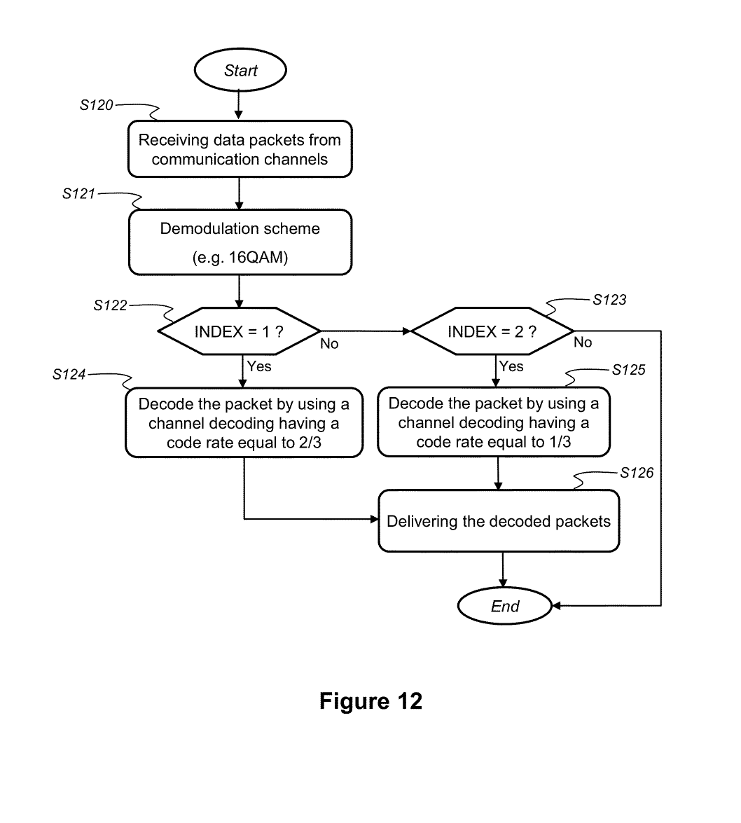

This global flowchart comprises a first main step S91b for receiving the primary and the secondary data streams in accordance with first and second reception parameters. According to one implementation of the invention, this first step concerns the configuring of the channel decoding and the demodulation as is detailed with reference to FIG. 12.

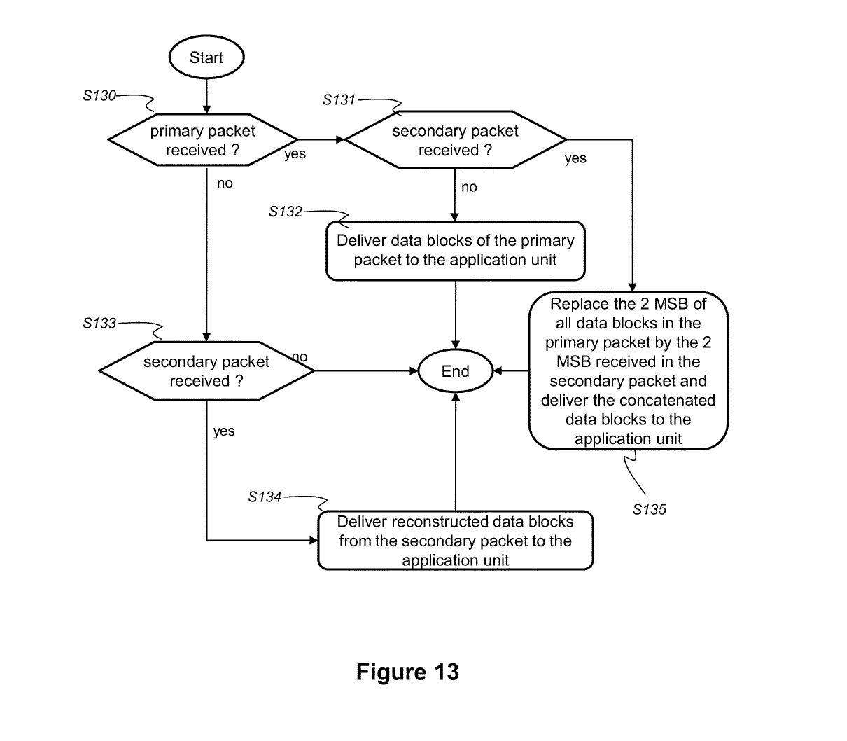

The flowchart further comprises a second main step S92b for recovering the data blocks based on data contained in the received primary and secondary data streams. This second step is detailed with reference to FIG. 13.

FIG. 10 illustrates the flowchart for forming the primary and secondary data streams according to the first embodiment of the invention.

At step S100, the primary data stream (referred to also as primary byte stream as data blocks correspond to bytes) is obtained by sub-sampling an uncompressed video frame according to 4:2:2 sub-sampling as described above.

At step S101, primary data packets are constructed by grouping n data blocks of the obtained primary data stream. A data packet represents the unit on which the channel coding will be applied. In fact, it is more efficient to encode a large number of data blocks as a single unit rather than encoding each data block (of 1 byte) individually. Thus, although n can be equal to 1, it is preferable to choose n so that to adapt the data packet size to the size that is appropriate for the implemented channel coder.

At step S102, an INDEX field is associated with each primary data packet and the value of this field is initialized to ‘1’. This field identifies each data packet as being primary data packet.

At step S103, the 2 most significant bits (MSB) of each data block of the primary data packets are selected and used for constructing secondary data packets. According to one implementation, the MSBs contained in one secondary data packet are only those of the data blocks of the corresponding primary data packet. In this case the size of a secondary data packet is four times smaller than that of a primary data packet. The secondary data packets may be further grouped when delivered to the channel encoder.

At step S104, an INDEX field is associated with each secondary data packet and the value of this field is initialized to ‘2’. This field identifies each data packet as being secondary data packet.

FIG. 11 illustrates the flowchart for encoding and modulating the primary and secondary data packets according to a first embodiment of the invention.

At step S110, the constructed data packets are obtained along with their associated INDEX field. If the obtained data packet is a primary data packet (test S111 on whether the INDEX is equal to 1 is positive), a channel coding with a code rate of 2/3 is applied (step S113). This code rate corresponds to a less robust coding. If the obtained data packet is a secondary data packet (test S112 on whether the INDEX is equal to 2 is positive), a channel coding with a code rate of 1/3 is applied (step S114). This code rate corresponds to a more robust coding. The channel coding for both primary and secondary data packets may be performed using a convolutional code (CC) for example. The encoded primary and secondary data packets are then both modulated using a 16 QAM modulation scheme for example (step S115). At step S116, the modulated packets are transmitted over their assigned communication channels (e.g. a given time-slot and transmission path).

FIG. 12 illustrates the flowchart for demodulating and decoding received primary and secondary data packets according to the first embodiment of the invention.

At step S120, primary and secondary data packets are received in the form of modulated signals from their assigned communication channels. At step S121, these signals are demodulated for retrieving encoded data packets along with INDEX information contained in the header of these packets. The demodulation is performed using the same modulation scheme and order than what the transmitter applied, i.e. a 16 QAM modulation scheme. If the demodulated data packet is a primary data packet (test S122 on whether the INDEX is equal to 1 is positive), a channel decoding with a code rate of 2/3 is applied (step S124). This code rate corresponds to a less robust coding. If the demodulated data packet is a secondary data packet (test S123 on whether the INDEX is equal to 2 is positive), a channel decoding with a code rate of 1/3 is applied (step S125). This code rate corresponds to a more robust coding. The channel decoding for both primary and secondary data packets applies the same coding scheme than what the transmitter applied, i.e. a convolutional code (CC). The decoded data packets are then delivered to the application unit 310 for recovering the data blocks to be used for reconstructing the uncompressed video frame (step S126).

FIG. 13 illustrates the flowchart for recovering a stream of data blocks according to a first embodiment of the invention.

It may happen that no signal is detected by the receiver if channel conditions are bad or, even if a signal has been detected, that the decoding of a demodulated packet is not successful. This means that a number of data packets will be missing and thus considered as not have been received. Data block recovery is consequently performed depending on which data packet is missing. Different tests (S130, S131, S133) are performed to determine if a given primary data packet and its corresponding secondary data packet, i.e. the one holding the MSBs of the data blocks of the primary data packet, are both received or only one of them is received.

If both primary and secondary data packets are received (tests 5130 and S131 positive), the 2 MSBs of all the data blocks in the primary data packet are replaced by the corresponding 2 MSBs received in the secondary data packet (step S135) to reduce the rate of residual errors—if any. The concatenated data blocks thus formed are delivered then to the application unit.

If only a primary data packet is received (tests S130 positive and S131 negative), the data blocks contained in the primary packet are delivered as such to the application unit.

If only a secondary data packet is received (tests S130 negative and S133 positive), data blocks are reconstructed using the MSBs contained in the secondary data packet and delivered to the application unit. The data blocks would contain only two bits of useful information. At the application level, missing information in the data blocks can be completed by appending 6 information bits (representing the least significant bits) to each 2 MSBs for reconstructing a complete data block. In one implementation, these appended bits are set to a mean value (‘100000’) for each color component. In an alternate and preferred implementation, these appended bits are determined from the values of the neighbouring pixel components by applying error concealment techniques.

If none of the primary and secondary data packets is received (tests S130 negative and S133 negative), the system fails to deliver data blocks to the application unit. It should be noted that because secondary data packets were more robustly protected, the probability of not receiving secondary data packets is lower than the probability of not receiving primary data packets.

It is to be noted that the required bandwidth for transporting both the primary and the secondary data streams over the communication system is equivalent to the bandwidth necessary for transporting a full 4:4:4 video stream using conventional transmission methods as shown in the table below. The invention provides thus in at least one of its embodiments an optimized bandwidth usage while increasing the robustness of the transmission of the video stream.

| | One video stream | Primary data stream | Secondary data stream |
|---|---|---|---|
| sub-sampling | 4:4:4 | 4:2:2 | 4:2:2 |
| Modulation | 16 QAM | 16 QAM | 16 QAM |
| | (4 bits per symbol) | (4 bits per symbol) | (4 bits per symbol) |
| channel coding | CC 2/3 | CC 2/3 | CC 1/3 |
| Video format | 1920 × 1080; 60 Hz | 1920 × 1080; 60 Hz | 1920 × 1080; 60 Hz |
| Pixel component coding | 8 bits | 8 bits | 8 bits |
| number of bits per pixel | 8 + 8 + 8 = 24 bits | 8 + 4 + 4 = 16 bits | (8 + 4 + 4)/4 = 4 bits |
| Necessary bandwidth | 1.119744 Gbps | 0.746496 Gbps | 0.373248 Gbps |

sum of primary and secondary =
1.119744 Gbps

### Second Embodiment

This second embodiment is similar to the first embodiment, except that the transmission/reception parameters used for transmitting and receiving the primary and secondary data streams are different. In the first embodiment, same data modulation (transceiver) parameters (16 QAM modulation scheme) and different data encoding (link control) parameters (coding rates of 1/3 and 2/3) are used for the primary and secondary data streams. In this second embodiment, same data encoding parameters (coding rate of 2/3) and different data modulation parameters (16 QAM modulation scheme and 4 QAM modulation scheme) are used for the primary and secondary data streams. These are two alternative ways of increasing robustness of one data stream relatively to the other. Equivalent result in terms of robustness can also be obtained in alternate embodiments by varying both the link control parameters and the transceiver parameters.

Figures for forming and recovering the primary and secondary data streams are similar to first embodiment and are not repeated here.

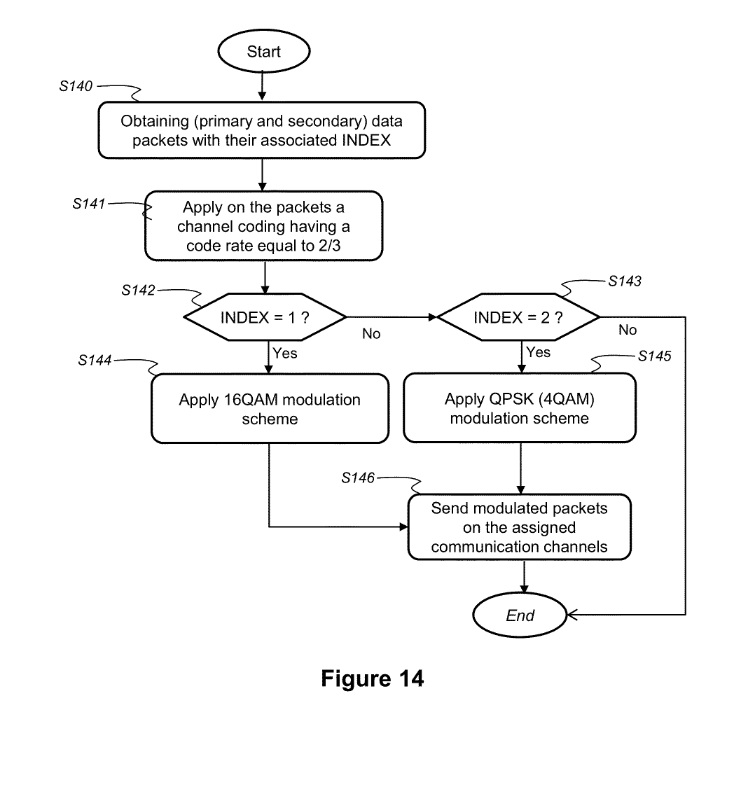

FIG. 14 illustrates the flowchart for encoding and modulating the primary and secondary data packets according to a second embodiment of the invention.

At step S140, the constructed data packets are obtained along with their associated INDEX field. In step S141, for all the obtained data packets a channel coding with a coding rate of 2/3 is applied. The channel coding may be performed using a convolutional code (CC) for example. If the encoded data packet is a primary data packet (test S142 on whether the INDEX is equal to 1 is positive), it is modulated using a 16 QAM modulation scheme (step S144). This order of modulation scheme (16) corresponds to a less robust modulation. If the encoded data packet is a secondary data packet (test S143 on whether the INDEX is equal to 2 is positive), it is modulated using a QPSK (4 QAM) modulation scheme (step S145). This order of modulation scheme (4) corresponds to a more robust modulation. At step S146, the modulated packets are transmitted over their assigned communication channels (e.g. a given time-slot and transmission path). In order to make it possible for the receiver to determine the type of the received data packet whether is it primary or secondary prior demodulating the data packet and thus prior accessing to the INDEX field, a signalling based on the assigned communication channels may be used. For example, a predetermined time slot can be assigned to primary data packets and another predetermined time slot can be assigned to secondary data packets. Alternatively, a predetermined transmission path, e.g. a line-of-sight (LOS) transmission path, can be assigned to primary data packets and another predetermined transmission path, e.g. any non-line-of-sight transmission path, can be assigned to secondary data packets.

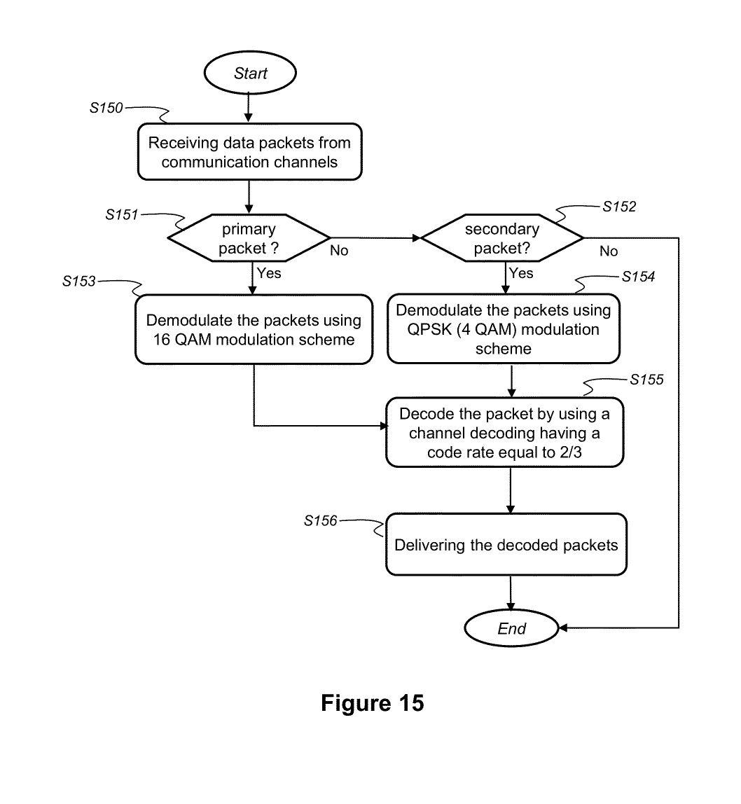

FIG. 15 illustrates the flowchart for demodulating and decoding received primary and secondary data packets according to the second embodiment of the invention.

At step S150, primary and secondary data packets are received in the form of modulated signals from their assigned communication channels. If the received data packet is received in a communication channel assigned to a primary data packet (test S151), it is demodulated using the same modulation scheme and order than what the transmitter applied for primary data packets, i.e. a 16 QAM modulation scheme. If the received data packet is received in a communication channel assigned to a secondary data packet (test S152), it is demodulated using the same modulation scheme and order than what the transmitter applied for secondary data packets, i.e. QPSK. At step S155, a channel decoding with a code rate of 2/3 is applied to the demodulated data packets. The decoded data packets are then delivered to the application unit 310 for recovering the data blocks to be used for reconstructing the uncompressed video frame (step S156).

### Third Embodiment

In this embodiment we consider a primary data stream formed by a 4:4:4 uncompressed video frames as depicted in FIG. 4. Pixel components are assumed to be coded with 8 bits and each data block of the primary stream corresponds to the 3 pixel components (24 bits). One symbol is taken equal to one byte, and thus N=3 symbols. It is furthermore assumed that M=1 symbol, which means that the most significant symbol (MSS) in this embodiment correspond to the most significant byte of the 3 bytes of the data block. Only the main figures that differ from the previous embodiments are described herebelow.

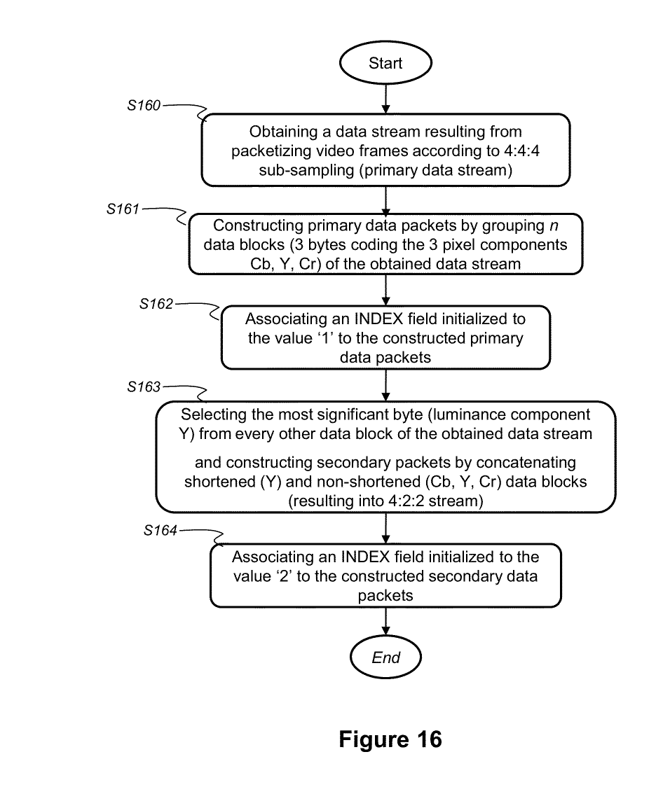

FIG. 16 illustrates the flowchart for forming the primary and secondary data streams according to the third embodiment of the invention.

At step S160, the primary data stream is obtained by packetizing video frames according to 4:4:4 sub-sampling. The resulting data stream is for example the arrangement of pixel components 490 illustrated in FIG. 4.

At step S161, primary data packets are constructed by grouping n data blocks of the obtained primary data stream. A data packet represents the unit on which the channel coding will be applied. In fact, it is more efficient to encode a large number of data blocks as a single unit rather than encoding each data block (of 3 bytes) individually. Thus, although n can be equal to 1, it is preferable to choose n so that to adapt the data packet size to the size that is appropriate for the implemented channel coder.

At step S162, an INDEX field is associated with each primary data packet and the value of this field is initialized to ‘1’. This field identifies each data packet as being primary data packet.

At step S163, the most significant byte of a number of data blocks of the primary data packets are selected and used for constructing secondary data packets. The most significant byte among the 3 components of a data block (Y, Cb, Cr) is the luminance component Y. In this embodiment, the significance of a symbol is not taken relatively to the position of the symbol in the data block but concerns the importance of that symbol when reconstructing and displaying the video frame.

Furthermore, in order to derive a secondary data stream that can still be used for display even if no primary data stream is received, not all the data blocks are shortened when constructing the secondary data packet. For example, the most significant byte (luminance component Y) is selected from every other data block. Secondary data packets are thus constructed by concatenating shortened (Y) and non-shortened data blocks (Cb, Y, Cr), hence resulting into a 4:2:2 sub-sampled data stream.

At step S164, an INDEX field is associated with each secondary data packet and the value of this field is initialized to ‘2’. This field identifies each data packet as being secondary data packet.

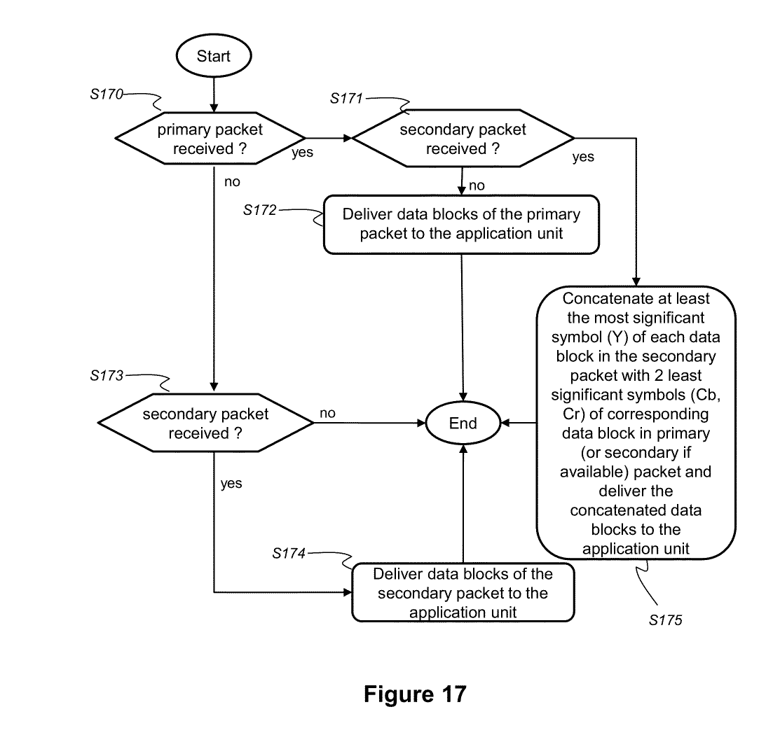

FIG. 17 illustrates the flowchart for recovering a stream of data blocks according to a third embodiment of the invention.

If both primary and secondary data packets are received (tests 5170 and S171 positive), the most significant symbol (component Y) of the shortened and non-shortened data blocks in the secondary data packet is concatenated to the corresponding two least significant symbols (components Cb, Cr) of the data blocks contained in the primary data packet (step S175) to reduce the rate of residual errors—if any.

Furthermore, the two least significant symbols (Cb, Cr) of the non-shortened data blocks in the secondary data packet are preferably used to reconstruct the data stream in place of those of the primary packet. Thus, non-shortened data blocks in the secondary data packet replace completely the corresponding data blocks in the primary data packet (less residual errors). The concatenated data blocks thus formed are delivered then to the application unit.

If only a primary data packet is received (tests S170 positive and S171 negative), the data blocks contained in the primary packet are delivered as such to the application unit (step S172).

If only a secondary data packet is received (tests S170 negative and S173 positive), the data blocks contained in the secondary packet are delivered as such to the application unit which corresponds to a 4:2:2 video stream (step S174). The video decoder in the application unit will then apply conventional interpolation/duplication techniques for retrieving values for all the components for the video frame pixels.

If none of the primary and secondary data packets is received (tests S170 negative and S173 negative), the system fails to deliver data blocks to the application unit. It should be noted that because secondary data packets were more robustly protected, the probability of not receiving secondary data packets is lower than the probability of not receiving primary data packets.

Although 1/3 and 2/3 have been provided as examples of code rate values and 4QAM and 16QAM have been provided as examples of modulation schemes in the above presented embodiments of the invention, it will be understood that other parameters values can also be envisaged. These values are preferably chosen to adapt differently the robustness of protection of the primary and secondary data packets and the bandwidth necessary for transporting those data packets.

FIG. 18 depicts a time division multiplexing (TDM) used for sharing access to the radio medium according to one of the embodiments of the invention.

Two time slots are provided periodically in every frame 1800 for carrying two radio packets 1802 and 1803. The start of a frame is signaled by means of a beacon signal 1801 that is sent in omni-directional way. The two radio packets 1802 and 1803 are used to transport the primary and secondary data packets, respectively. Radio packet 1802 is transmitted according to a first transmission path, e.g. P0. Radio packet 1803 is transmitted according to a second transmission path, e.g. P1. Primary data packets are thus transported over a first communication channel defined by the association of the first transmission path and the time slot carrying radio packet 1802. Secondary data packets are transported over a second communication channel defined by the association of the second transmission path and the time slot carrying radio packet 1803.

The radio packets 1802 and 1803 contains a field RPH (Radio Packet Header) represented by 1804 and 1806 and a field RPP (Radio Packet Payload) represented by 1805 and 1807. The Radio Packet Header, as represented by 1806, is composed of three sub-fields: the preamble (Pr) sub-field 1808, the SIZE sub-field 1809 and the INDEX sub-field 1810. The preamble 1808 is used for frame detection and synchronization by the physical layer of the receiver device. The SIZE 1809 indicates the size in bytes of the Radio Packet Payload and the INDEX 1810 indicates the type of the transported data packet, i.e. primary data packet or secondary data packet. Radio Packet Header 1804 and the header of each other radio packet have a similar structure.

1. A method of transmitting data over a communication system, comprising:
obtaining a primary data stream comprising data blocks, each data block being formed by a plurality of N symbols;
forming a secondary data stream comprising shortened data blocks formed from the M most significant symbols of data blocks of the primary data stream, where M<N; and
transmitting the primary and secondary data streams in accordance with, respectively, first and second transmission parameters;
wherein the first and second transmission parameters cause the transmitting of the secondary data stream to be more robust against transmission errors than the transmitting of the primary data stream.

2. A method according to claim 1, comprising, prior to the transmitting, a step of setting the first and the second transmission parameters for causing the transmitting of the secondary data stream to be more robust against errors than the transmitting of the primary data stream.

3. A method according to claim 2, wherein the first and second transmission parameters include data encoding parameters and data modulation parameters.

4. A method according to claim 3, wherein the data encoding parameters include a code rate of an error correction code, and setting the first and second transmission parameters comprises setting the code rate of the first transmission parameters to be greater than the code rate of the second transmission parameters.

5. A method according to claim 3, wherein the data modulation parameters include an order of modulation scheme and setting the first and second transmission parameters comprises setting the modulation scheme order of the first transmission parameters to be greater than the modulation scheme order of the second transmission parameters.

6. A method according to claim 1, wherein the primary and secondary data streams are transmitted in data packets and wherein an indication of the type of the embodied data stream is transmitted in a header of each data packet.

7. A method according to claim 1, wherein each data block contains information of at least one pixel component of an uncompressed video frame.

8. A method according to claim 7, wherein each data block contains the encoding of one pixel component and wherein a shortened data block contains the two most significant bits of the pixel component contained in a corresponding data block.

9. A method according to claim 7, wherein each data block contains the encoding of three pixel components (Cb, Y, Cr) and wherein a shortened data block contains the luminance component (Y) contained in a corresponding data block.

10. A method of receiving data over a communication system, comprising:
receiving a primary data stream in accordance with first reception parameters, the primary data stream comprising data blocks formed by a plurality of N symbols;
receiving a secondary data stream in accordance with second reception parameters, the secondary data stream comprising shortened data blocks formed from the M most significant symbols of data blocks of the primary data stream, where M<N, and wherein the first and second reception parameters correspond to a more robust protection against transmission errors of the secondary data stream relatively to the primary data stream; and
recovering data blocks based on data contained in the received primary and secondary data streams.

11. A method according to claim 10, wherein if both a first data block of the primary data stream and a second data block of the secondary data stream corresponding to the first data block are received, the recovering comprises a step of concatenating the M most significant symbols of the second data block with the N-M least significant symbols of the first data block.

12. A method according to claim 11, wherein if the first data block is not received and the second data block is received and is a shortened data block, the recovering comprises the steps of:
determining N-M symbols by applying an error concealment or interpolation technique; and
concatenating the M most significant symbols of the second data block with the determined N-M symbols.

13. A method according to claim 11, wherein if the first data block is received and the second data block is not received, the recovering consists in selecting the first data block as a recovered data block.

14. A method according to claim 10 comprising, prior to the receiving, a step of configuring reception means with first and second reception parameters for enabling the receiving of primary and secondary data streams.

15. A transmitting device for transmitting data over a communication system, comprising:
means for obtaining a primary data stream comprising data blocks, each data block being formed by a plurality of N symbols;
means for forming a secondary data stream comprising shortened data blocks formed from the M most significant symbols of data blocks of the primary data stream, where M<N; and
means for transmitting the primary and secondary data streams in accordance with, respectively, first and second transmission parameters;
wherein the first and second transmission parameters causing the transmitting of the secondary data stream to be more robust against transmission errors than the transmitting of the primary data stream.

16. A receiving device for receiving data over a communication system, comprising:
means for receiving a primary data stream in accordance with first reception parameters; the primary data stream comprising data blocks formed by a plurality of N symbols;
means for receiving a secondary data stream in accordance with second reception parameters, the secondary data stream comprising shortened data blocks formed from the M most significant symbols of data blocks of the primary data stream, where M<N, and wherein the first and second reception parameters correspond to a more robust protection, against transmission errors, of the secondary data stream relatively to the primary data stream; and
means for recovering data blocks based on data contained in the received primary and secondary data streams.
